(19) United States
(12) Patent Application Publication
(10) Pub. No.: US 2005/0165501 A1
(43) Pub. Date: Jul. 28, 2005

(54) Apparatus and method for the use of memory devices for audio

(76) Inventors: Yam Fei Lian, Singapore (SG); Chin Fang Lim, Singapore (SG)

Correspondence Address: Stephen M. De Klerk;BLAKELY, SOKOLOFF, TAYLOR & ZAFMAN LLP, Seventh Floor, 12400 Wilshire Boulevard, Los Angeles, CA, 90025, US

(21) Appl. No.: 10/763,622

(22) Filed: Jan. 23, 2004

(51) Int. Cl. G06F 17/00

(52) U.S. Cl. 700/94

(57) ABSTRACT

Apparatus for enabling a portable electronic memory module to be able to be used to replay audio when the portable electronic memory module is operatively attached to the apparatus, the apparatus comprising; a port for operatively connecting with an interface connector of the memory module for transfer of audio signals between the memory module and the apparatus, and power from the apparatus to the memory module; a controller for controlling the audio signals, the controller comprising a host controller, an interface controller for controlling the interface and a buffer memory for receiving the audio signals from the portable electronic memory module; an audio amplifier; a source of power; and a connector for output of audio; and a processor for controlling and supplying data to a display on the apparatus, and for controlling output of audio signals. A method is also disclosed.

### FIELD OF THE INVENTION

This invention relates to apparatus and method for the use of memory devices for audio and refers particularly, though not exclusively, to such an apparatus and method to enable portable electronic memory and storage devices to be used for storage and replay of audio.

### BACKGROUND TO THE INVENTION

There are presently on the market a large range of portable electronic memory or storage devices that, in the main, use “flash” memory to store data. They have an interface to enable them to be directly connected to a part of a computer or the like to download or upload data. The interface is commonly a USB interface. Such products are fast becoming the medium of choice for removable data storage, and are replacing the floppy disk.

Also on the market are a large range of portable audio products for storing and replaying audio, mostly music. Many of these are audio players use the MP3 standard. Most, but not all, also use an interface for direct connection to a computer or the like. That interface may be a USB interface.

In both instances an IEEE 1394 interface may also be used.

At present, a portable electronic memory or storage device intended solely for data cannot be used for storage and reply of audio.

### SUMMARY OF THE INVENTION

In accordance with a preferred aspect of the present invention there is provided apparatus for enabling a portable electronic memory module to be able to be used to replay audio when the portable electronic memory module is operatively attached to the apparatus, the apparatus comprising;
a port for operatively connecting with an interface connector of the memory module for transfer of audio signals between the memory module and the apparatus, and power from the apparatus to the memory module;
a controller for controlling the audio signals, the controller including a host controller, an interface controller for the interface, and a buffer memory for receiving the audio data from the portable electronic memory module;
an audio amplifier;
a source of power; and
a connector for output of audio.

The transfer of audio data may be from the memory module to the apparatus and the apparatus to the memory module, but is only one-way at any one time.

There may be further included a processor for controlling and supplying data to a display on the apparatus, and for controlling output of audio signals.

The connector may also be for the input of audio data; and may also be for input of video signals.

There may be further included an image processor including an image sensor module, and an audio amplifier.

In a further preferred form there is provided a method for using an apparatus for playing audio stored in a portable electronic memory module, the method comprising:
(a) operatively connecting the portable electronic memory module to the apparatus to enable the audio to be transferred to the apparatus;
(b) reading and playing audio data stored in the portable electronic memory module;
(c) transferring the audio data into a buffer memory and playing the audio data from the buffer memory;
(d) continuing to transfer the audio data to the buffer memory while continuing to play the audio data from the buffer memory until the buffer memory is full then suspending operation of the portable electronic memory module;
(e) upon the buffer memory being substantially empty, reactivating the portable electronic memory module and reading audio data from the electronic memory module into the buffer memory until the buffer memory is full;
(f) repeating steps (d) and (e).

In step (c) playing from the buffer memory may not commence until a predetermined storage level in the buffer memory is reached.

The audio may be decoded and/or decrypted as it is read; and the audio may be subsequently amplified, and sent to an audio outlet for playing.

Between steps (a) and (b), file information may be read from the portable electronic memory module and displayed in a display of the apparatus.

The relatively low level may be substantially empty, and is preferably greater than the predetermined storage level.

### BRIEF DESCRIPTION OF THE DRAWINGS

In order that the invention may be fully understood and readily put into practical effect, there shall now be described by way of non-limitative example only preferred embodiments of the present invention, the description being with reference to the accompanying illustrative drawings in which:

FIG. 1 is a perspective view of a storage device in use with on embodiment of the present invention;

FIG. 2 is a perspective view of the embodiment of FIG. 1 with the parts separated;

FIG. 3 is an illustrative block diagram of a first embodiment of the apparatus;

FIG. 4 is an illustrative block diagram of a second embodiment of the apparatus; and

FIG. 5 is a flow chart for operation of the apparatus.

### DETAILED DESCRIPTION OF THE PREFERRED EMBODIMENTS

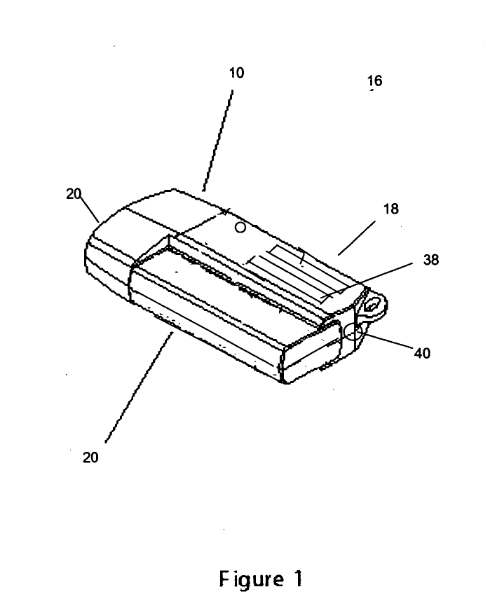

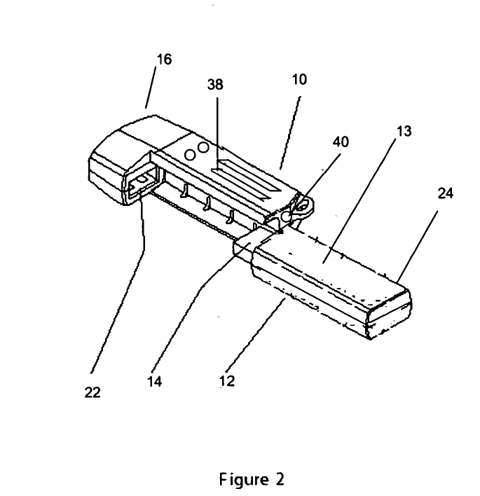

To refer to FIGS. 1 and 2, there is shown an apparatus 10 for use with a portable electronic data storage module 12. The module 12 may be of any suitable type, category or make, and may have any storage capacity. Generally module 12 will have flash memory. Apparatus 10 is preferably also portable, and more preferably is “pocket sized”. The portable electronic data storage module 12 is separable from the apparatus 10 and may be used for storage of one or more of data, audio, images, and video.

Module 12 has an interface connector 14 to enable it to connect directly to a corresponding port on a computer or the like. The interface may be an IEEE 1394 interface or, as shown, a USB interface.

The apparatus 10 has a casing 16 and is generally L-shaped with a body 18 and an arm 20. The module 12 is generally parallel to body 18 when engaged with apparatus 10.

In arm 20 is a port 22 corresponding to interface 14. Port 22 may be an IEEE 1394 or USB port.

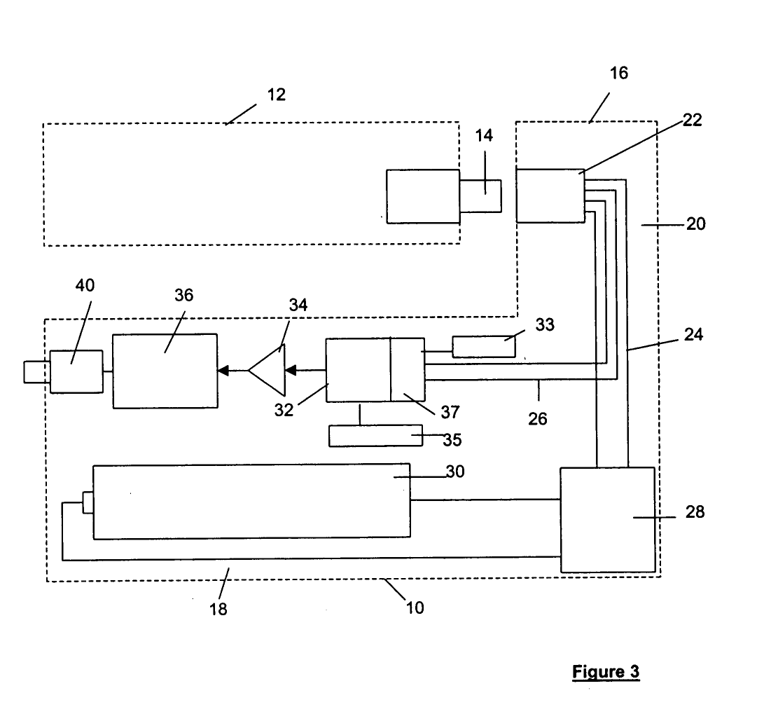

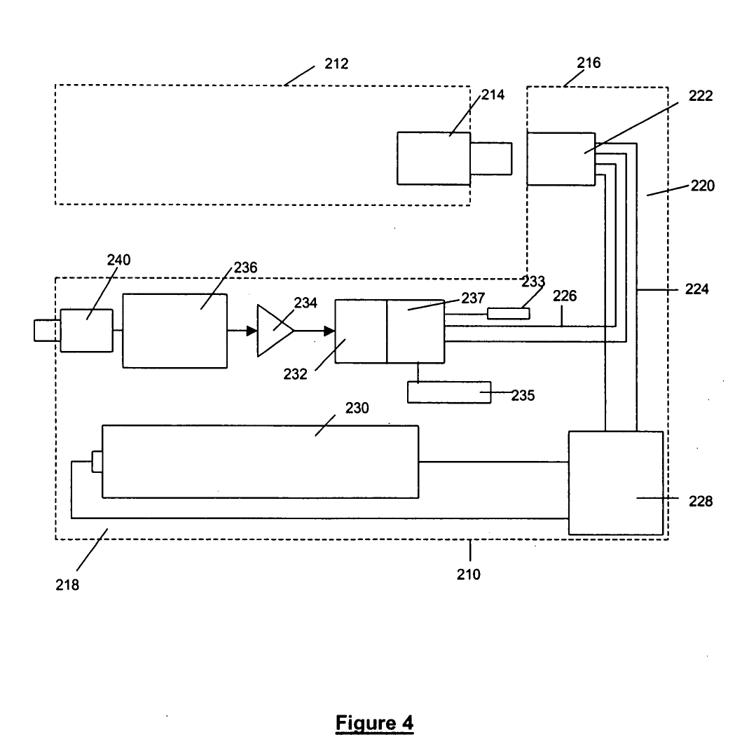

As shown in FIGS. 3 and 4, port 22 has at least four lines connected to it including power lines 24 and data lines 26. Power lines 24 include active and ground lines. Power lines 24 are operatively connected to a power supply unit 28 and hence to a power source 30 such as, for example, a battery. Power lines 24 enable power to be passed from apparatus 10 to module 12 to operate module 12.

The data lines 26 enable audio data to be passed to module 12 from apparatus 10, and from module 12 to apparatus 10. Preferably, audio data is only one-way at any one time. Audio data may be analog or digital.

Apparatus 10 includes a controller 32 for controlling data and/or audio passing in either or both directions between module 12 and apparatus 10. Controller 37 is operatively connected to data lines 26. Operatively connected to controller 32 is an amplifier 34 for amplifying audio data passed from module 12 to apparatus 10 via connector 14 and port 22. The amplifier 34 may be a digital or analog amplifier.

Controller 32 includes a host controller 37, and a controller 33 for the interface, thereby allowing all forms of memory modules 12 with the same, standard interface and standard memory functions, to be used with apparatus 10.

Controller 32 also preferably includes a buffer memory 35. Preferably, the buffer memory 35 is a volatile memory such as, for example, SRAM or SDRAM. The buffer memory 35 is used to store data received from memory module 12 so that the memory module 12 is turned off after buffer memory 35 is full, and memory module 12 is switched on only to download more data to the buffer memory 35 when and as required. The data may be audio data including but not limited to, data in accordance with the MP3/WMA standard. The memory buffer 35 may be of any suitable size such as, for example, 4 MB. This would provide about 4 minutes of MP3 audio data.

The output from amplifier 34 is to a display and audio output controller and processor 36. Processor 36 controls the operation of and sends data and instructions to display 38 on apparatus 10. It also sends the audio signal to a connector 40 to which may be connected an earpiece, earphones, headphones, speakers, or other audio reproduction device (not shown) in a known manner. If amplifier 34 is a digital amplifier, processor 36 may include a digital-to-analog converter.

Connector 40 may also be used to input data and/or audio (analog and/or digital) to apparatus for storage in module 12. In this case controller 32 may include a recording controller module.

The operation of apparatus 10 is by use of control buttons or switches 42, 44, 46 and 48. Other controls may be used as required or desired. Controls may include controls of one or more of : on, off volume, play, stop, pause, track, fast forward/reverse, menu selector, menu cursor and selector, and so forth. Menu items will appear on display 38.

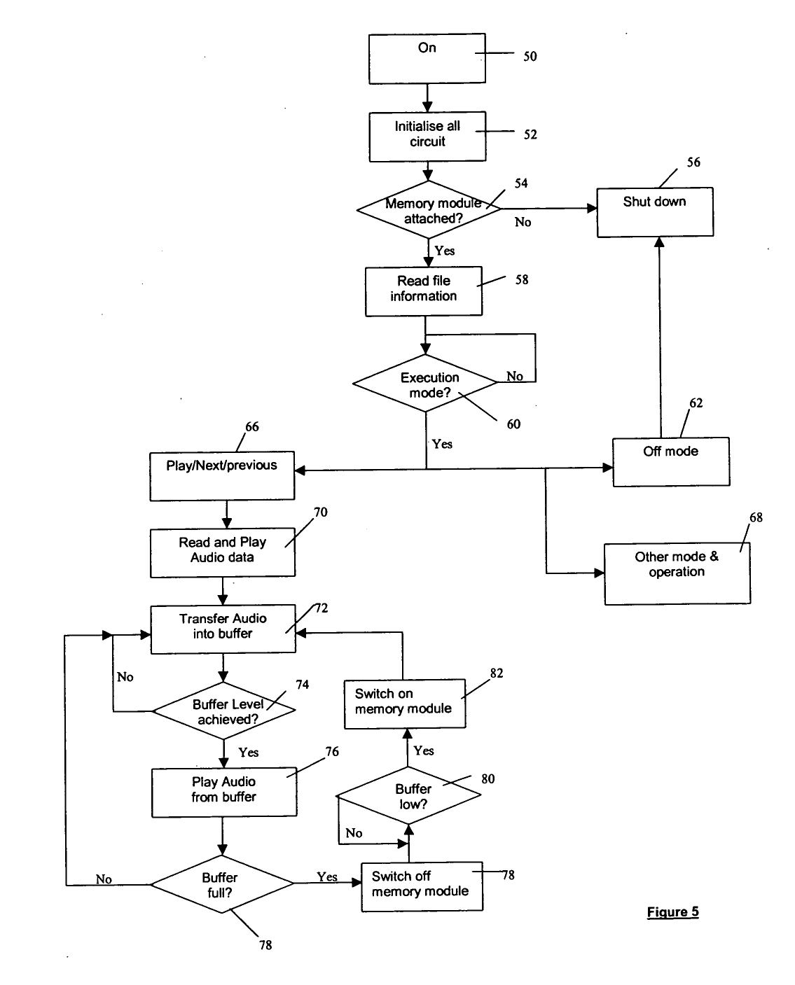

FIG. 5 is a flow chart of the operation. Upon the memory module being attached to apparatus 10, and the power control for apparatus 10 being switched on (50), all internal circuits in apparatus 10 are initialized (52) and a check made to determine if memory module 12 is attached (54). If the result of the query is no, the apparatus 10 shuts down (56). If yes, the list of files in the memory module 12 are read (58) and appropriate information displayed on display 38. Apparatus 10 then awaits an instruction (60).

When an instruction is entered, it may be to switch off (62) in consequence of which apparatus 10 shuts down (56). Another instruction entered may be a play-related function such as, for example, one or more of play, next, previous, and so forth (66). Alternatively, it may be another form of function such as, for example, volume up, volume down, pause, and so forth (68).

When a play-related function is selected at 66, the audio data is read from memory module 12 and, if in an encoded and/or compressed format such as, for example, MP3, it is decoded as it is read (70). The audio can then be played as streaming data. The audio is continually transferred to the buffer memory 35 (72). When a predetermined storage level in buffer memory 35 is achieved (74), the audio is played from the buffer memory 35 (76). The predetermined storage level may be, for example, 512 bytes. The size of the buffer memory 35 allows the memory module 12 to be shut down for periods of, for example, about 4 minutes for MP3 standard audio data if the memory buffer 35 is 4MB. The larger the buffer memory 35, the longer the off period, thus conserving power. The audio play (72) continues from the memory buffer 35 when memory module 12 is off.

When the buffer memory 35 is full (78) the host controller 37 suspends, or switches off, the operation of memory module 12 (78). If the buffer memory 35 is not full at 76, audio is continued to be transferred (72). When the buffer memory 35 is low (80) the audio transfer recommences (72). Until the buffer memory 35 is low, the memory module is switched off (82) and memory module 12 remains in the suspended, or off, mode (78). When the buffer memory 35 is low, the memory module is switched on (82) and memory module 12 remains on until the buffer memory 35 is again full. Preferably, the buffer memory 35 does not empty below the predetermined storage level so that audio data continues to be read from buffer memory 35. In this way buffer memory 35 is kept above the predetermined storage level. Alternatively, the buffer memory 35 may be allowed to become substantially empty.

In this way, all functionality for enabling and/or controlling audio playback is in apparatus 10, not memory module 12. By including that functionality in apparatus 12 any memory module 12 with the required interface, and standard memory, can be used with apparatus 10 for audio, or audio/video, storage and playback. This include MP3 audio.

FIG. 4 shows a variation of the embodiment of FIG. 3. Like references are used for like components but with a prefix number 2. The principal differences are for when video, or audio/video, is input through connector 240 for storage in module 212. In this case processor 236 may include an image sensor, and an audio amplifier; and controller 232 may include a recording module.

Whilst there has been described in the foregoing description preferred embodiments of the present invention, it will be understood by those skilled in the technology concerned that many variations or modifications in details of design, construction or operation may be made without departing from the present invention.

1. Apparatus for enabling a portable electronic memory module to be able to be used to replay audio when the portable electronic memory module is operatively attached to the apparatus, the apparatus including;
a port for operatively connecting with an interface connector of the memory module for transfer of audio signals between the memory module and the apparatus, and power from the apparatus to the memory module;
a controller for controlling the audio signals, the controller comprising a host controller, an interface controller for controlling the interface, and a buffer memory for receiving the audio signals from the portable electronic memory module;
an audio amplifier;
a source of power; and
a connector for output of audio.

2. Apparatus as claimed in claim 1, wherein the transfer of audio signals is from the memory module to the apparatus and the apparatus to the memory module, but is only one-way at any one time.

3. Apparatus as claimed in claim 1, further comprising a processor for controlling and supplying data to a display on the apparatus, and for controlling output of audio signals.

4. Apparatus as claimed in claim 1, wherein the connector is also for the input of audio signals.

5. Apparatus as claimed in claim 1, wherein the connector is also for input of video signals.

6. Apparatus as claimed in claim 1, further comprising a processor including an image sensor module, and an audio amplifier.

7. Apparatus as claimed in claim 1, wherein the controller comprises a host controller, a controller for the interface, and a buffer memory for receiving the audio signals from the portable electronic memory module.

8. A method for using an apparatus for playing audio stored in a portable electronic memory module, the method comprising:
(a) operatively connecting the portable electronic memory module to the apparatus to enable the audio to be transferred to the apparatus;
(b) reading audio data stored in the portable electronic memory module;
(c) transferring the audio data into a buffer memory and playing the audio from the buffer memory;
(d) continuing to transfer the audio data to the buffer memory while continuing to play the audio data from the buffer memory until the buffer memory is full then suspending operation of the portable electronic memory module;
(e) upon the buffer memory being substantially empty, reactivating the portable electronic memory module and reading audio data from the electronic memory module into the buffer memory until the buffer memory is full;
(f) repeating steps (d) and (e).

9. A method as claimed in claim 8, wherein in step (b) the playing of audio from the buffer memory does not commence until a predetermined storage level in the buffer memory is reached.

10. A method as claimed in claim 8, wherein the audio is decoded and decrypted as it is read.

11. A method as claimed in claim 8, wherein the audio is amplified, and sent to an audio outlet for playing.

12. A method as claimed in claim 8, wherein, between steps (a) and (b), file information is read from the portable electronic memory module and displayed in a display of the apparatus.

13. A method as claimed in claim 8, wherein the relatively low level is substantially empty.

14. A method as claimed in claim 11, wherein the relatively low level is greater than the predetermined storage level.
